(19) United States
(12) Patent Application Publication
(10) Pub. No.: US 2021/0192317 A1
(43) Pub. Date: Jun. 24, 2021

(54) INFORMATION PROCESSING DEVICE, INFORMATION PROCESSING METHOD, AND PROGRAM

(71) Applicants: Kabushiki Kaisha Toshiba, Tokyo (JP); Toshiba Digital Solutions Corporation, Kawasaki-shi (JP)

(72) Inventor: Ryohei TANAKA, Kawasaki (JP)

(73) Assignees: Kabushiki Kaisha Toshiba, Tokyo (JP); Toshiba Digital Solutions Corporation, Kawasaki-shi (JP)

(21) Appl. No.: 17/121,990

(22) Filed: Dec. 15, 2020

(30) Foreign Application Priority Data
Dec. 18, 2019 (JP) 2019-228171

(51) Int. Cl. G06N 3/04; G06K 9/62

(52) U.S. Cl. CPC G06N 3/04; G10L 15/22; G06K 2209/01; G06K 9/6277

(57) ABSTRACT

An information processing device, an information processing method, and a program capable of rejecting only a part of a series in a recognition process performed in units of series are provided. An information processing device includes a rejection class adding unit, a label sequence selecting unit, and an output unit. The rejection class adding unit adds a rejection class by acquiring a categorical distribution sequence formed by aligning a plurality of categorical distributions having scores for each class and acquiring a score of a rejection class on the basis of the categorical distribution for each of the categorical distributions included in the categorical distribution sequence. The label sequence selecting unit calculates likelihoods of label sequence candidates corresponding to the categorical distribution sequence on the basis of the categorical distribution sequence after addition of the rejection class and selects a label sequence among a plurality of the label sequence candidates in accordance with the likelihoods of the label sequence candidates. The output unit outputs the selected label sequence.

### BACKGROUND OF THE INVENTION

### Field of the Invention

Embodiments of the present invention relate to an information processing device, an information processing method, and a program.

### Description of Related Art

Technologies for recognition processing in units of series are used. More specifically, a technique called connectionist temporal classification (CTC) is used. By performing recognition in units of series, an accuracy higher than that of a case in which recognition is performed in units of symbols constituting a series can be acquired. The reason for this is that recognition processing not only depending on features in units of symbols but also using features as a series can be performed. In a conventional technology for recognition processing in units of series, in a case in which the reliability of a result of the recognition processing is low or the like, rejection (discard) of the result of the recognition processing is performed. However, in the recognition processing in units of series, a target that is rejected is the entire series. In such a conventional technology, even in a case in which only a part of a series has a low reliability, the entire series needs to be rejected. In other words, there is a problem that a part of the information acquired in the process of recognition processing cannot be effectively utilized.

### PATENT DOCUMENTS

[Patent Document 1] Japanese Unexamined Patent Application, PCT Publication No. 2018/216511
[Patent Document 2] Japanese Patent No. 3533773
[Patent Document 3] Japanese Patent No. 2658104

### SUMMARY OF THE INVENTION

An object of the present invention is to provide an information processing device, an information processing method, and a program capable of rejecting only a part of a series in recognition processing performed in units of series.

An information processing device according to an embodiment includes a rejection class adding unit, a label sequence selecting unit, and an output unit. The rejection class adding unit adds a rejection class by acquiring a categorical distribution sequence formed by aligning a plurality of categorical distributions having scores for each class and acquiring a score of a rejection class on the basis of the categorical distribution for each of the categorical distributions included in the categorical distribution sequence. The label sequence selecting unit calculates likelihoods of label sequence candidates corresponding to the categorical distribution sequence on the basis of the categorical distribution sequence after addition of the rejection class and selects a label sequence among a plurality of the label sequence candidates in accordance with the likelihoods of the label sequence candidates. The output unit outputs the selected label sequence.

### BRIEF DESCRIPTION OF THE DRAWINGS

FIG. 1 is a block diagram illustrating a schematic functional configuration of an information processing device according to a first embodiment;

FIG. 2 is a flowchart illustrating a processing sequence of an information processing device according to the first embodiment;

FIG. 3 is a graph illustrating an example of a categorical distribution sequence input to an information processing device according to the first embodiment, the horizontal axis being a time step, and the vertical axis being a likelihood;

FIG. 4 is a graph illustrating results of processing performed by an information processing device according to the first embodiment (a basic type), the horizontal axis being a time step, and the vertical axis being a likelihood;

FIG. 5 is a graph illustrating results of processing performed by an information processing device according to the first embodiment (a fourth modified example), the horizontal axis being a time step, and the vertical axis being a likelihood;

FIG. 6 is a block diagram illustrating a schematic functional configuration of an information processing device according to a second embodiment; and

FIG. 7 is a flowchart illustrating a processing sequence of an information processing device according to the second embodiment.

### DETAILED DESCRIPTION OF THE INVENTION

Hereinafter, an information processing device, an information processing method, and a program according to embodiments will be described with reference to the drawings.

### First Embodiment

An information processing device according to this embodiment acquires a result of recognition of a series recognition problem using a CTC. The CTC represents a connectionist temporal classification. Specific examples of the series recognition problem include recognition processes such as a speech recognition, a character string recognition, and a gesture recognition. The information processing device according to this embodiment is applicable to all such series recognition problems. For example, the speech recognition is a process of receiving speech as an input and outputting text (character string) corresponding to the speech. In addition, for example, the character string recognition is a process of receiving an image of a printed character string using handwritten characters or a predetermined font as an input and outputting text (character string) corresponding to the image. For example, the gesture recognition is a process of receiving signals of a time series detected by a sensor (for example, a touch panel, an acceleration sensor, or the like) detecting a person's gesture as an input and outputting a sequence of symbols corresponding to the gesture.

In this embodiment, a categorical distribution is a discrete probability distribution representing probabilities of a plurality of classes. In other words, the categorical distribution is a set of classes, and each of the classes has a probability value. The probability value corresponds to a value called a likelihood, a certainty factor, a score, or the like in this embodiment. The probability value is a normalized numerical value. Here, being normalized represents that, for a certain categorical distribution, a sum of numerical values of classes belonging to the categorical distribution is 1. A numerical value called a likelihood, a certainty factor, a score, or the like may be normalized or non-normalized in the meaning described above.

The categorical distribution sequence is a series of a categorical distribution, in other words, a set having a sequence.

The information processing device according to this embodiment takes in a categorical distribution sequence as an input and selects and outputs a maximum-likelihood label sequence on the basis of the categorical distribution sequence. An input categorical distribution sequence, for example, is calculated on the basis of feature quantities representing features of an image, speech, a quantity that is physically detected, a statistical value, and the like. The information processing device according to this embodiment may be configured to include a process of generating a categorical distribution sequence based on such feature quantities.

A label is associated with a class. An arrangement of labels corresponding to classes included in a categorical distribution within a categorical distribution sequence is a label sequence. A mapping function to be described below can map a label sequence onto another label sequence. A length of a label sequence may be changed by the mapping function. Classes include a normal class, a blank class, and a rejection class. In correspondence with such classes, a normal label, a blank label, and a rejection label are respectively present. The normal class corresponds to labels configuring a label sequence that is acquired as a result of recognition. The blank class corresponds to a blank. For example, in the process of handwritten character recognition, a blank area between a character and a character is a blank. In addition, for example, in the process of speech recognition, a section of muteness (or only noise) between a phoneme and a phoneme is a blank. Blanks in the other application areas are similar thereto. The rejection class is a class that is a target for rejection. For example, a case in which it is difficult to determine a class of a recognition target, a case in which a likelihood of a specific class is too low (for example, the likelihood is less than a predetermined threshold), and the like correspond to the rejection class.

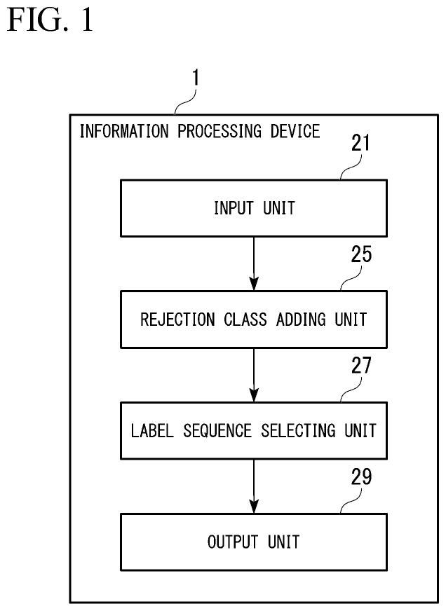

FIG. 1 is a block diagram illustrating a schematic functional configuration of an information processing device according to this embodiment. As illustrated in the drawing, the information processing device 1 includes an input unit 21, a rejection class adding unit 25, a label sequence selecting unit 27, and an output unit 29. Each of such functional units, for example, is realized using an electronic circuit. In addition, each of the functional units may include a storage unit such as a semiconductor memory or a magnetic hard disk device like as is necessary. Each function may be realized by a computer and software.

The input unit 21 acquires a categorical distribution sequence. The categorical distribution sequence can be acquired on the basis of features of a target. The input unit 21 may obtain a categorical distribution sequence acquired by an external device or the like or may directly acquire a categorical distribution sequence on the basis of feature quantities of a target.

The rejection class adding unit 25 receives a categorical distribution sequence from the input unit 21. Then, the rejection class adding unit 25, for each categorical distribution included in a categorical distribution sequence, acquires a score of a rejection class on the basis of the categorical distribution. The rejection class adding unit 25 adds a rejection class having the acquired score to the categorical distribution. A categorical distribution sequence that is a target to be processed by the rejection class adding unit 25 is formed as a series by arranging a plurality of categorical distributions having scores for each class.

The label sequence selecting unit 27 calculates a likelihood of a label sequence candidate corresponding to a categorical distribution sequence on the basis of the categorical distribution sequence after addition of the rejection class. The label sequence selecting unit 27 selects a specific label sequence from among a plurality of label sequence candidates in accordance with calculated likelihoods of the label sequence candidates. The label sequence selecting unit 27, for example, selects one label sequence having the highest likelihood. For example, the label sequence selecting unit 27 may select label sequences of up to a higher n-th (here, n is a positive integer) rank. In addition, the label sequence selecting unit 27 may not necessarily select a label sequence having the highest likelihood.

The label sequence selecting unit 27 may use a mapping function. The mapping function is for mapping from a sequence of labels corresponding to each categorical distribution configuring a categorical distribution sequence (for the convenience of description, this will be referred to as a first label sequence) onto a sequence of labels to be finally output (for the convenience of description, this will be referred to as a second label sequence). Generally, the mapping function is many-to-one mapping. In other words, one identical output may be configured to be in correspondence with a plurality of different inputs for the mapping function. Although details will be described below, for example, the label sequence selecting unit 27 acquires a first label sequence likelihood for each first label sequence on the basis of likelihoods of classes included in a categorical distribution sequence (likelihoods of classes in each categorical distribution). Then, the label sequence selecting unit 27 sets a result of an application of a predetermined mapping function to the first label sequence as a second label sequence. The label sequence selecting unit 27 acquires a second label sequence likelihood for each second label sequence on the basis of the first label sequence likelihood of the first label sequence associated with the second label sequence using the mapping function. In other words, the label sequence selecting unit 27 can acquire a set of first label sequences as a result of an application of an inverse function of the mapping function described above to the second label sequence. Thus, a sum of likelihoods of the first label sequences (a first label sequence likelihood) is set as a likelihood of the second label sequence (a second label sequence likelihood). The label sequence selecting unit 27 uses the second label sequences as the label sequence candidates described above and selects a label sequence to be output from among such second label sequences on the basis of the second label sequence likelihood.

The output unit 29 outputs the label sequence selected by the label sequence selecting unit 27 to the outside.

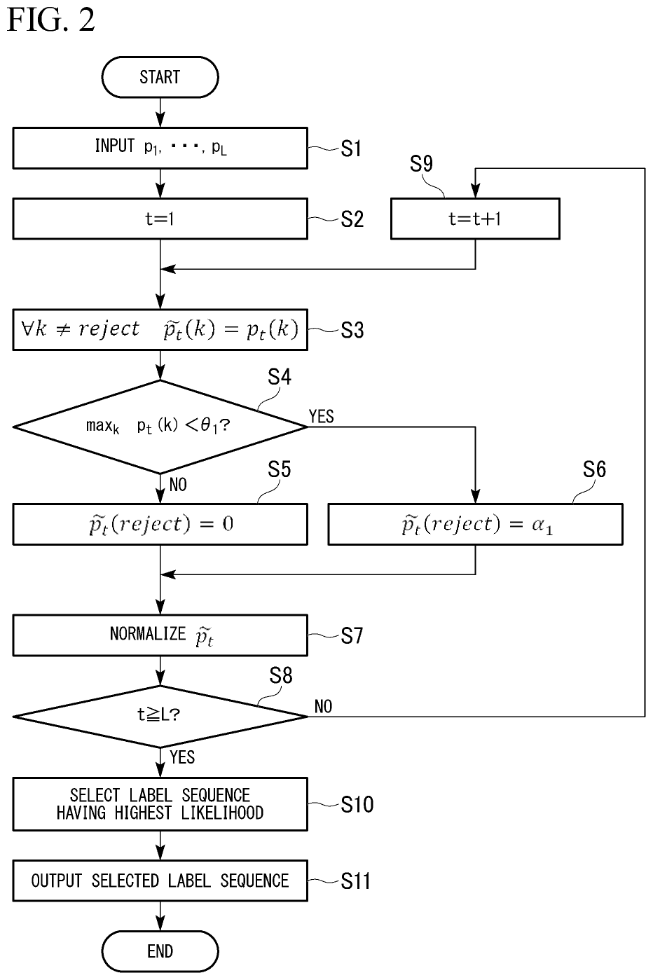

FIG. 2 is a flowchart illustrating a processing sequence of the information processing device 1 according to this embodiment. Hereinafter, the sequence will be described along this flowchart.

In Step S1, the input unit 21 acquires categorical distribution sequences p₁, . . . , p_{L} from the outside. These categorical distribution sequences p₁, . . . , p_{L} have been acquired on the basis of features of data that is a recognition target.

In Step S2, the information processing device 1 initializes t, which is a variable indicating a position within the categorical distribution sequence, to 1.

In processes of Steps S3 to S7, the rejection class adding unit 25 adds a rejection class to the categorical distribution pₜ indicated by the variable t. A specific process of each step is as follows.

In Step S3, the rejection class adding unit 25 directly sets a likelihood pₜ(k) of a class k included in input data as a score after insertion of the rejection class. Here, the class k is a normal class or a blank class.

In Step S4, the rejection class adding unit 25 determines whether or not a value of a maximum value (maxₖ pₜ(k)) of a likelihood pₜ(k) at the time t is less than a threshold 01. The threshold 01 will be described below. In a case in which the maximum value of the likelihood pₜ(k) is less than the threshold θ₁ (Step S4: Yes), the process proceeds to Step S6. In a case in which the maximum value of the likelihood pₜ(k) is equal to or more than the threshold θ₁ (Step S4: No), the process proceeds to Step S5.

In Step S5, the rejection class adding unit 25 sets the score of the rejection class to be added to “0”. After end of this step, the process proceeds to the process of Step S7.

In Step S6, the rejection class adding unit 25 sets the score of the rejection class to be added to α₁. Here, α₁ is a positive value that is set appropriately. After end of this step, the process proceeds to the process of Step S7.

In Step S7, the rejection class adding unit 25 normalizes the categorical distribution pₜ (tilde) after addition of the rejection class. By performing normalization, for example, the rejection class adding unit 25 sets a sum of scores of all the classes including the rejection class to 1 for the time t.

In Step S8, the information processing device 1 determines whether or not t≥L. In other words, in this step, the information processing device 1 determines whether or not the process for all the positions t in the input categorical distribution sequence has ended. In the case of t≥L (Step S8: Yes), the process proceeds to Step S11. In the case of t<L (Step S8: No), the process proceeds to Step S9.

In a case in which the process proceeds to Step S9, the information processing device 1 increments the value of t for advancing the position within the categorical distribution sequence. In other words, the value of (t+1) is substituted into the variable t. After the process of this step, the information processing device 1 returns to the process of Step S3.

In a case in which the process proceeds to Step S10, the label sequence selecting unit 27 selects a label sequence having the highest likelihood on the basis of the categorical distribution sequence after addition of the rejection class. Details of selection using the label sequence selecting unit 27 will be described below.

In Step S11, the output unit 29 outputs the label sequence selected in Step S10 to the outside. The label sequence output in this step is a result of recognition acquired by the information processing device 1 on the basis of the categorical distribution sequence acquired by the input unit 21. When the process of this step ends, the information processing device 1 ends the process of the entire flowchart.

Next, the internal process of the information processing device 1 will be described in more detail.

The CTC uses a processing method of receiving a categorical distribution series including a blank class in addition to a class that is the original recognition target as an input and calculating a likelihood of a specific label sequence. As described above, the input unit 21 acquires L categorical distribution sequences p₁, . . . , p_{L} as inputs.

For such categorical distribution sequences p₁, . . . , p_{L}, a likelihood of a label sequence l is calculated using the following Equation (1).

$$p ( l ) = {\sum }_{π ∈ {ℬ}^{- 1} ( l )} {\prod }_{t = 1}^{L} {p}_{t} ( {π}_{t} ) \qquad ( 1 )$$

Here, B is a mapping function for deleting a blank label and deleting consecutive identical labels (here, one label among such consecutive identical labels is caused to remain).

B⁻¹ in Equation (1) is an inverse function of the function B described above. In other words, B⁻¹(l) represents a set of paths that can be converted into 1 by the function B. Such a path matches a label sequence including a blank label and is a label sequence of a length L. pₜ(πₜ) represents a probability of a t-th label πₜ of a path π in a categorical distribution sequence pₜ. As a result of the CTC processing, generally, a label sequence having a highest likelihood that has been calculated is output as a result of the prediction.

The input unit 21 acquires categorical distribution sequences p₁, . . . , p_{L} composed of L categorical distributions that do not include rejection classes and include blank labels (Step S1 illustrated in FIG. 2).

The rejection class adding unit 25 adds a rejection class to each of the L categorical distributions p₁, . . . , p_{L}. More specifically, in a case in which a score of a class that is a first-ranked candidate included in the categorical distribution pₜ (1≤t≤L) is less than a threshold θ₁, the rejection class adding unit 25 adds a rejection class having a predetermined score α₁ (Step S6 illustrated in FIG. 2). In other cases, in other words, in a case in which the score of the class that is the first-ranked candidate included in the categorical distribution pₜ(1≤t≤L) is equal to or more than the threshold θ₁, the rejection class adding unit 25 adds a rejection class having a score of “0” (Step S5 illustrated in FIG. 2). Here, θ₁, for example, may be an integer that is set appropriately. In addition, at, for example, may be also an integer that is set appropriately.

In this way, the rejection class adding unit 25 acquires \tilde{p}₁, . . . , \tilde{p}_{L} that is a categorical distribution after addition of the rejection class. In other words, pₜ to which a tilde has been assigned is a categorical distribution after addition of the rejection class.

As described above, the categorical distribution after addition of the rejection class to be added is as represented in the following Equations (2) and (3).

$$\begin{matrix}{\tilde{p}}_{t} ( reject ) = \{ \begin{matrix}{α}_{1 } ( if {max}_{k} {p}_{t} ( k ) < {θ}_{1} ) \\ 0 ( otherwise )\end{matrix} & ( 2 ) \\ \text{∀} k \neq reject \\ \tilde{{p}_{t}} ( k ) = {p}_{t} ( k ) & ( 3 )\end{matrix}$$

The rejection class adding unit 25 may perform normalization such that a sum of scores of categorical distributions after addition of the rejection class is “1” (Step S7 illustrated in FIG. 2). As one example of the normalization method, there is a method of dividing the value of a score of each class belonging to pₜ (tilde) by the sum of scores of all the classes (including the rejection class) of the categorical distribution p (tilde) t.

By performing the normalization as such, \tilde{p}₁, . . . , \tilde{p}_{L} can be handled as a probability scale and can be calculated with the same scale as that of p₁, . . . , p_{L}.

Here, the normalization process is not essential as in a case in which calculation with the same scale as that of categorical distribution sequences p₁, . . . , p_{L} is not necessary or the like.

The value of the score of the k-th class of the t-th categorical distribution after normalization is represented in the following Equation (4).

$${\tilde{p}}_{t} ( k ) = {\tilde{p}}_{t} ( k ) / {\sum }_{m}^{ } {\tilde{p}}_{t} ( m ) \qquad ( 4 )$$

In addition, the rejection class adding unit 25 may configure α₁ represented in Equation (2) as being infinite.

In a case in which α₁ is configured as being infinite, in a case in which the score of a first-ranked class within the categorical distribution is less than 01, and in a case in which the normalization represented in Equation (4) is performed, \tilde{p}₁, . . . , \tilde{p}₁, is represented in the following Equation (5).

$${\tilde{p}}_{t} ( k ) = \{ \begin{matrix}1 ( if k = reject ) \\ 0 ( otherwise )\end{matrix} \qquad ( 5 )$$

The reason for configuring α₁ as being infinite is that the categorical distribution represented in Equation (5) can be acquired as a result of normalization using Equation (4). Instead, regardless of the value of α₁, in a case in which the score of the first-ranked class within the categorical distribution is less than θ₁, normalization as in Equation (5) as a definition may be performed.

In other words, in this embodiment, in a case in which the score of a class that is the first-ranked candidate within the categorical distribution is equal to or more than a predetermined threshold (θ₁), the rejection class adding unit 25 sets the score of the rejection class to a lowest value among scores of all the classes. “0” in a lower level of the right side represented in Equation (2) is a lowest value in a case in which the value of the score of the class takes a value equal to or more than 0 and equal to or less than 1. On the other hand, in a case in which the score of the class that is the first-ranked candidate within the categorical distribution is less than the predetermined threshold (θ₁), the rejection class adding unit 25 sets the score of the rejection class to a predetermined value (α₁) other than the lowest value. In other words, for example, in a case in which the value of the score of the class takes a value equal to or more than 0 and equal to or less than 1, it is set such that α₁>0.

The label sequence selecting unit 27 selects a label sequence lₒᵤₜ having a highest likelihood on the basis of the categorical distribution sequence to which the rejection class has been added. The selected label sequence lₒᵤₜ may include a rejection label. Calculation for determining a label sequence lₒᵤₜ to be selected is as represented in Equations (6) and (7).

$$\begin{matrix}p ( l ) = {\sum }_{π ∈ {ℬ}_{M}^{- 1} ( l )} {\prod }_{t = 1}^{L} {\tilde{p}}_{t} ( {π}_{t} ) & ( 6 ) \\ {l}_{out} = {argmax }_{l} p ( l ) & ( 7 )\end{matrix}$$

Equation (6) is a numerical equation for acquiring a score of a label sequence l. In other words, the score of the label sequence l is a sum of likelihoods of paths π in which the label sequence l can be acquired by applying the mapping function BM. A likelihood of a path π is calculated as a product of likelihoods of sequences πₜ (1≤t≤L) composing the path π (based on the categorical distribution having a rejection class).

In addition, as represented also in Equation (6), when a likelihood of a label sequence is acquired, the label sequence selecting unit 27 uses a mapping function BM. The mapping function B described above is a function of deleting a blank label and deleting consecutive identical labels. In contrast to this, the mapping function BM performs an operation of, in a case in which a normal label and a rejection label are adjacent to each other, deleting the rejection label at that position and causing the normal label to remain together with deleting a blank label and deleting consecutive identical labels.

Table 1 is a table for a comparison between the function B and the function BM. This table represents outputs of the function B and the function BM for predetermined examples of an input label sequence 7E. For the convenience of description, a row number is assigned to each row of the table.

TABLE 1
Comparison between B and B_{M}

| | π | B(π) | B_{M}(π) |
|---|---|---|---|
| 1 | a_?_ _b | a?b | a?b |
| 2 | a_??_b | a?b | a?b |
| 3 | a?_ _b_ | a?b | ab |
| 4 | a?_? ? b | a?b | ab |

a, b: normal label,
_: blank label,
?: rejection label

In Table 1, rejection labels appearing in a first row and a second row are not adjacent to a normal label and are separated by a blank label. Thus, such rejection labels remain in an output label sequence not only in a case in which the function B is applied but also in a case in which the function BM is applied. On the other hand, rejection labels appearing in a third row and a fourth row are adjacent to a and b that are normal labels. Such rejection labels remain within the output label sequence in a case in which the function B is applied and are deleted in a case in which the function BM is applied.

In other words, by using a first label sequence as an argument, the mapping function BM performs an operation of (1) deleting a blank label from the first label sequence, (2) in a case in which consecutive identical labels are present within the first label sequence, substituting the consecutive identical labels with only one of the labels (only one of the labels is caused to remain), and (3) in a case in which there is a position at which a normal label and a rejection label are consecutive within the first label sequence, deleting the rejection label and causing the normal label to remain regardless of which one of the normal label and the rejection label precedes the other. A result of the operation is a second label sequence that is an output value of the mapping function B_{M}. An inverse function of the mapping function B_{M} uses the second label sequence described above as an argument and has a set of corresponding first label sequences as an output value.

According to this embodiment, the rejection class adding unit 25 adds rejection classes not to the entire categorical distribution sequence but to each categorical distribution among them and gives appropriate scores to such rejection classes. In accordance with this, not rejection of the entire label sequence but rejection in units of labels can be performed (a rejection label can be given within the label sequence to be output).

In addition, according to this embodiment, the B_{M} is used as a mapping function. In this way, in a case in which there is a position at which a normal label and a rejection label are consecutive in the first label sequence, the rejection label is deleted, and the normal label is caused to remain regardless of which one of the normal label and the rejection label precedes the other. In other words, a more appropriate label sequence can be selected and output.

Next, a first modified example of this embodiment will be described. Here, special items of this modified example will be focused on in the description. Points that are not particularly mentioned here are similar to the items that have been described in this embodiment.

In this modified example, a mapping function BR is used instead of the mapping function B_{M}. The mapping function B_{M} performs the operation of, in a case in which a normal label and a rejection label are adjacent to each other, deleting the rejection label at the position thereof and causing the normal label to remain. Here, in a case in which there is a position at which a normal label and a rejection label are adjacent to each other, the mapping function BR converts the entire label sequence into a label sequence that is an exclusion target.

Table 2 is a table for a comparison between the function B and the function B_{M}, and the function B_{R}. This table represents outputs of the function B, the function B_{M}, and the function B_{R} for predetermined examples of an input label sequence 7C. For the convenience of description, a row number is assigned to each row of the table.

TABLE 2
Comparison between B, B_{M}, and B_{R}

| | π | B(π) | B_{M}(π) | B_{R}(π) |
|---|---|---|---|---|
| 1 | a_?_ _b | a?b | a?b | a?b |
| 2 | a_??_b | a?b | a?b | a?b |
| 3 | a?_ _b_ | a?b | ab | exclusion |
| 4 | a?_??b | a?b | ab | exclusion |

a, b: normal label,
_: blank label,
?: rejection label

As illustrated in Table 2, the mapping function B_{R} outputs “exclusion” for a label sequence including a position at which a and b, which are normal labels, and a rejection label are adjacent to each other. In other words, when an inverse function of the mapping function B_{R} is applied to a certain label sequence l, a label sequence including a pattern in which a normal label and a rejection label are adjacent to each other such as “a?__b_” and “a?_??b” is not included in a set output by B_{R}⁻¹(I) This has an effect of reducing the amount of calculation that is necessary for calculating a likelihood of the label sequence l.

In other words, by using the first label sequence as an argument, the mapping function B_{R} performs an operation of (1) deleting the blank labels described above from the first label sequence and (2), in a case in which consecutive identical labels are present within the first label sequence, substituting the consecutive identical labels with only one of the labels. A result of the operation is a second label sequence that is an output value of the mapping function B_{R}. Here, in a case in which there is a position at which a normal label and a rejection label are consecutive within the first label sequence, an exclusion target label sequence (may be simply referred to as “exclusion”) is set as a second label sequence that is an output value of the mapping function B_{R} regardless which one of the normal label and the rejection label precedes the other. An inverse function of the mapping function B_{R} uses the second label sequence described above as an argument and has a set of corresponding first label sequences as an output value.

In this modified example, the label sequence selecting unit 27 performs calculation using the following Equations (8) and (9) and selects a label sequence lₒᵤₜ having a highest likelihood.

$$\begin{matrix}p ( l ) = {\sum }_{π ∈ {ℬ}_{R}^{- 1} ( l )} {\prod }_{t = 1}^{L} {\tilde{p}}_{t} ( {π}_{t} ) & ( 8 ) \\ {l}_{out} = {argmax }_{l} p ( l ) & ( 9 )\end{matrix}$$

In other words, as represented in Equation (8), in this modified example, the label sequence selecting unit 27 uses the inverse function of the mapping function B_{R}. In other words, the label sequence selecting unit 27 sets a sum of likelihoods of paths π that become a label sequence l when the mapping function B_{R} is applied as a likelihood of the label sequence l.

In this modified example, B_{R} is used as the mapping function. In accordance with this, in a case in which there is a position at which a normal label and a rejection label are consecutive within the first label sequence, a corresponding second label sequence is set as an exclusion target label sequence regardless of which one of the normal label and the rejection label preceding the other. In this way, the process of calculating likelihoods of candidates for a label sequence can be simply implemented. In other words, the amount of calculation can be reduced.

Next, a second modified example of this embodiment will be described. Here, special items of this modified example will be focused on in the description. Points that are not particularly mentioned here are similar to the items that have been described in this embodiment (including other modified examples).

In this modified example, there is a feature in the sequence of a process when the label sequence selecting unit 27 selects a label sequence having a maximum likelihood. More specifically, in this modified example, the label sequence selecting unit 27 acquires a maximum likelihood path π* formed by aligning labels of which likelihood is a maximum in each categorical distribution \tilde{p}₁, . . . , \tilde{p}_{L}. Then, the label sequence selecting unit 27 selects B(π*) that is a result acquired by converting the maximum likelihood path π* using the mapping function B as an output label sequence.

In other words, in this modified example, the label sequence selecting unit 27 selects an output label sequence lₒᵤₜ using the following Equations (10), (11), and (12).

π*=″π₁*π₂* . . . π_{L}*″ (10)

πₜ*=argmaxₖ\tilde{p}ₜ(k) (11)

lₒᵤₜ= [symbol] (π*) (12)

As represented in Equation (11), πₜ* (here, 1≤t≤L) is a label corresponding to a maximum likelihood class in a t-th categorical distribution (here, in the rejection class). In addition, “π₁*π₂* . . . π_{L}*” is a label sequence (path) in which π₁* to π_{L}* are aligned in that order.

In other words, in this modified example, the label sequence selecting unit 27 acquires a first label sequence likelihood for each first label sequence on the basis of a likelihood of a class included in a categorical distribution sequence (a likelihood in each categorical distribution). The label sequence selecting unit 27 selects a predetermined number of (one or a plurality of) first label sequences in accordance with the first label sequence likelihood among a plurality of first label sequences. The label sequence selecting unit 27 selects a second label sequence that is a result of an application of a predetermined mapping function to the selected first label sequence as a label sequence to be output.

Here, the mapping function may be the mapping function B described above. In other words, the mapping function B performs an operation of (1) deleting a blank label from the first label sequence and (2), in a case in which consecutive identical labels are present within the first label sequence, substituting the consecutive identical labels with only one of the labels. The mapping function B sets a result of the operation as a second label sequence that is an output value.

The mapping function B used in Equation (12) may be substituted with the mapping function B_{M} or B_{R} described above.

According to this modified example, the number of cases of combinations at the time of acquiring a likelihood of a label sequence decreases. In other words, a similar effect can be acquired with simpler implementation, in other words, with a smaller amount of calculation.

Next, a third modified example of this embodiment will be described. Here, special items of this modified example will be focused on in the description. Points that are not particularly mentioned here are similar to the items that have been described in this embodiment (including other modified examples).

In this modified example, there is a feature in the method of adding a rejection class. In this modified example, the rejection class adding unit 25 assigns a score of a rejection class on the basis of a difference between likelihoods of a first-ranked candidate and a second-ranked candidate in each categorical distribution pₜ before addition of the rejection class.

More specifically, the rejection class adding unit 25 calculates \tilde{p}₁, . . . , \tilde{p}_{L} using the following Equations (13) and (14). Here, pₜ^{1st} and pₜ^{2nd} respectively represent the likelihood of the first-ranked candidate and the likelihood of the second-ranked candidate of pₜ. Here, 1≤t≤L.

$$\begin{matrix}{\tilde{p}}_{t} ( reject ) = \{ \begin{matrix}{α}_{1} ( if {p}_{t}^{1 st} - {p}_{t}^{2 nd} < {θ}_{2} ) \\ 0 ( otherwise )\end{matrix} & ( 13 ) \\ \text{∀} k \neq reject \\ {\tilde{p}}_{t} ( k ) = {p}_{t} ( k ) & ( 14 )\end{matrix}$$

As represented in Equation (13), in this modified example, the rejection class adding unit 25 adds a rejection class having a predetermined score α₁ (α₁>0) to the categorical distribution in which a difference between likelihoods of the first-ranked candidate and the second-ranked candidate of the categorical distribution pₜ (1≤t≤L) is less than a predetermined threshold θ₂. In the other case (in other words, in a case in which the difference between the likelihoods of the first-ranked candidate and the second-ranked candidate is equal to or more than θ₂), the rejection class adding unit 25 adds a rejection class having a score of “0”.

The value of α₁ is as described above. In addition, the value of the threshold θ₂, for example, may be a positive integer given in advance.

The method of assigning a score of a rejection class may be further generalized and may be as below. In a case in which a difference between a first-ranked score of a class that is a first-ranked candidate within a categorical distribution and a second-ranked score of a class that is a second-ranked candidate within the categorical distribution is equal to or more than a predetermined threshold (θ₂), the rejection class adding unit 25 sets the score of the rejection class to a lowest value among the scores of all the classes. One example of this lowest value is 0 represented in a lower level of the right side of Equation (13). For example, the range of a value of the score of a class may be set to be equal to or more than 0 and equal to or less than 1. On the other hand, in a case in which a difference between a first-ranked score of a class that is a first-ranked candidate within a categorical distribution and a second-ranked score of a class that is a second-ranked candidate within the categorical distribution is less than the predetermined threshold (θ₂), the rejection class adding unit 25 sets the score of the rejection class to a predetermined value other than the lowest value described above. One example of this “predetermined value” is α₁ represented in an upper level of the right side of Equation (13).

As a new modified example, in any one of a case in which the likelihood of the first-ranked candidate is less than the threshold θ₁ described above and a case in which a difference between the likelihoods of the first-ranked candidate and the second-ranked candidate is less than the threshold θ₂ described above, a rejection class of which a score is α₁ may be assigned. In the other case, a rejection class of which a score is 0 is assigned.

In addition, also in this modified example, the rejection class adding unit 25 may be configured to normalize scores of the categorical distribution after addition of the rejection class using Equation (4) described above or the like.

According to this modified example, a score of the rejection class is assigned on the basis of a relative relation between the score of the first-ranked candidate and the score of the second-ranked candidate. In other words, in this modified example, while the number of hyper parameters to be adjusted increases, improvement of the rejection performance can be expected.

Next, a fourth modified example of this embodiment will be described. Here, special items of this modified example will be focused on in the description. Points that are not particularly mentioned here are similar to the items that have been described in this embodiment (including other modified examples).

In this modified example, there is a feature in the method of adding a rejection class. In this modified example, in a case in which a likelihood of a first-ranked candidate is less than a threshold θ₁ and the first-ranked candidate is a blank class in a categorical distribution pₜ (1≤t≤L) before addition of a rejection class, the rejection class adding unit 25 adds a rejection class having a predetermined score α₁ (here, α₁>0). On the other hand, in the other case, the rejection class adding unit 25 adds a rejection class having a score of “0”.

In other words, in this modified example, the rejection class adding unit 25 calculates a categorical distribution after addition of the rejection class \tilde{p}₁, . . . , \tilde{p}_{L} using the following Equations (15) and (16).

$$\begin{matrix}{\tilde{p}}_{t} ( reject ) = \{ \begin{matrix}{α}_{1} ( if {max}_{k} {p}_{t} ( k ) < {θ}_{1} ⋂ {argmax }_{k} p ( k ) = blank ) \\ 0 ( otherwise )\end{matrix} & ( 15 ) \\ \text{∀} k \neq reject \\ {\tilde{p}}_{t} ( k ) = {p}_{t} ( k ) & ( 16 )\end{matrix}$$

Here, the values of θ₁ and α₁ are as described above. In addition, also in this modified example, the rejection class adding unit 25 may be configured to perform normalization using Equation (4) or the like after addition of the rejection class.

As described above, in this modified example, a condition of the first-ranked candidate being a blank class in the categorical distribution is a necessary condition for adding a valid rejection. In this modified example, by setting only blanks as targets for rejection, a rejection function targeted only for label deletion can be realized.

A graph illustrated in FIG. 5 next is a graph in which p₁, . . . , p_{L} and \tilde{p}₁, . . . , \tilde{p}_{L} are drawn with the vertical axis representing a likelihood and the horizontal axis representing a series (time steps) t=1, . . . , L.

A condition for assigning a score α₁ may be acquired by combining the basic type according to the first embodiment and the third modified example.

In other words, in this modified example, in a case in which the score of a class that is a first-ranked candidate within a categorical distribution is equal to or more than a predetermined threshold (θ₁) or in a case in which the class that is the first-ranked candidate is not a blank class corresponding to a blank, the rejection class adding unit 25 sets the score of the rejection class to a lowest value among scores of all the classes. “0” illustrated in a lower level of the right side of Equation (15) is one example of this lowest value (for example, in a case in which the range of the value of the score is set to be equal to or more than 0 and equal to or less than 1).

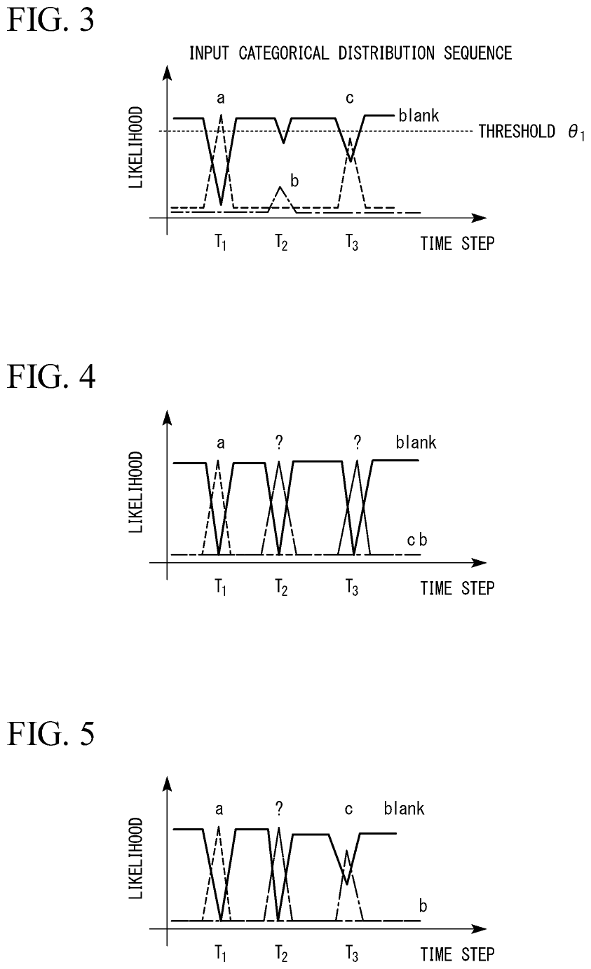

FIGS. 3, 4, and 5 are graphs illustrating differences between processing results in a case in which the same categorical distribution sequence is input to each of the basic pattern of this embodiment and the fourth modified example.

For example, such graphs are examples of a case in which a handwritten character recognizing process is performed.

FIG. 3 is a graph illustrating a categorical distribution sequence acquired by the input unit 21.

FIG. 4 is a graph illustrating a result acquired by performing a process on the basic pattern of this embodiment.

FIG. 5 is a graph illustrating a result acquired by performing a process of the fourth modified example of this embodiment.

In the graphs illustrated in FIGS. 3, 4, and 5, the horizontal axis represents a time step (series), and the vertical axis represents a likelihood (score).

FIG. 3 illustrates graphs of changes of likelihoods of a total of four classes including a, b, and c, which are normal classes, and a blank class according to a time step. Here, T₁, T₂, and T₃ represent predetermined positions on the horizontal axis. In addition, a broken line drawn in the horizontal direction represents a threshold θ₁ relating to likelihoods. As illustrated in the drawing, in the example of this input (categorical distribution sequence), the likelihood of the normal class a rises at the position T₁ and becomes a first-ranked candidate. At the position T₁, the likelihood of the blank class falls below the threshold θ₁. At the position T₂, the likelihood of the blank class falls below the threshold θ₁, and the first-ranked candidate at the position T₂ is a blank class. At the position T₂, the likelihood of the normal class b rises but is quite lower than the likelihood of the blank class. At the position T₂, there is no class having a likelihood that is equal to or more than the threshold θ₁. At the position T₃, the likelihood of the normal class c is above the likelihood of the blank class and becomes the first-ranked candidate. However, including the normal class c and the blank class, there is no class having a likelihood that is equal to or more than the threshold θ₁ at the position T₃. In addition, at positions that are not near each of the positions T₁, T₂, and T₃, as a whole, the blank class is the first-ranked candidate, and the likelihood thereof is equal to more than the threshold θ₁.

In FIG. 4, in addition to the normal classes a, b, and c and the blank class included in the input, a rejection class is added. In addition, in FIG. 4, likelihoods of all the classes are normalized such that it has a sum value of “1.0”. As illustrated in the drawing, as a result of the process performed by the rejection class adding unit 25, the first ranked candidate at the position T₁ is the normal class a. The first-ranked candidate at the position T₂ is the rejection class. The first-ranked candidate at the position T₃ is the rejection class. By applying a mapping function, the blank label is deleted. Thus, in this case, the information processing device 1 outputs “a??” as a result of decoding.

Also in FIG. 5, in addition to normal classes a, b, and c and a blank class included in an input, a rejection class is added. Also in FIG. 5, a sum value of likelihoods of all the classes are normalized such that the sum value thereof is 1.0. As illustrated in the drawing, as a result of the process performed by the rejection class adding unit 25, a first-ranked candidate at the position T₁ is the normal class a.

A first-ranked candidate at the position T₂ is the rejection class. In other words, the first-ranked candidate at each of the positions T₁ and T₂ is similar to that of the case illustrated in FIG. 4. At the position T₃, in the process of this fourth modified example, the first-ranked candidate is not the blank class, and thus the score of the rejection class is determined as being 0 in accordance with Equation (15). Thus, the first-ranked candidate at the position T₃ is the normal class c. In addition, by applying a mapping function, the blank class is deleted. Thus, in this case, the information processing device 1 outputs “a?c” as a result of decoding.

Next, a fifth modified example of this embodiment will be described. Here, special items of this modified example will be focused on in the description. Points that are not particularly mentioned here are similar to the items that have been described in this embodiment (including other modified examples).

A feature of this modified example is a value of the score assigned to a rejection class. In this modified example, the rejection class adding unit 25 applies a predetermined function f to the value of the maximum likelihood (a likelihood of the first-ranked candidate) in a categorical distribution pₜ (1≤t≤L) before addition of the rejection class and sets the function value thereof as the score of the rejection class. In other words, the rejection class adding unit 25 adds a rejection class having a score represented in the following Equation (17) to a t-th categorical distribution within the categorical distribution sequence.

$$f ( {max}_{t} {p}_{t} ) \qquad ( 17 )$$

In this way, the rejection class adding unit 25 calculates \tilde{p}₁, . . . , \tilde{p}_{L} after addition of the rejection class. In other words, the calculation is as represented in Equation (18).

$${\tilde{p}}_{t} ( reject ) = f ( {max}_{t} {p}_{t} ) \qquad ( 18 )$$

The domain of the function f(x) includes the range of a value that may be taken by the likelihood of a class included in pt. For example, the domain is 0≤x≤1. In addition, f(x) is monotonous decreasing function (a monotonous decreasing function). In other words, when 0≤x₁<x₂≤1, f(x₁)≥f(x₂). Alternatively, when 0≤x₁<x₂≤1, it may be configured such that f(x₁)>f(x₂). By using such f(x), the score of the rejection class can be configured to be lower as the likelihood of the class of the first-ranked candidate becomes higher, and the score of the rejection class can be configured to be higher as the likelihood of the class of the first-ranked candidate becomes lower.

By using the domain as 0≤x≤1, examples of the function f(x) include f(x)=1−x or f(x)=(x−1)\hat{ }2.

In other words, in this modified example, the rejection class adding unit 25 sets a value (a value given by the function f(x) described above) that monotonously decreases (monotonously decreases) with respect to the score of a class that is the first-ranked candidate within the categorical distribution before addition of the rejection class as the score of the rejection class in the categorical distribution.

According to this modified example, the score of the rejection class can be changed in accordance with the score of a class that is the first-ranked candidate.

Here, an example of the operation of the information processing device 1 according to the first embodiment will be described. Table 3 represented below illustrates an example of a categorical distribution sequence after addition of a rejection class performed by the rejection class adding unit 25. The values of likelihoods in this categorical distribution are normalized. In other words, a sum of likelihoods of classes in each time step is 1. In this example, the length of the categorical distribution sequence is 2. In other words, only 1 and 2 are included as time steps. As the classes, there are three types including a normal class a, a blank class, and a rejection class. Numerical values recorded in the table are likelihoods of classes in each time step.

TABLE 3
INPUT EXAMPLE

| | | TIME STEP | |
|---|---|---|---|
| | | 1 | 2 |
| CLASS | a | 0.9 | 0.2 |
| | — | 0.1 | 0.1 |
| | ? | 0.0 | 0.7 |

a, b: normal label,
_: blank label,
?: rejection label

As illustrated in Table 3, when the time step is 1, the likelihood of a, which is a first-ranked candidate, exceeds a threshold θ1, and thus the likelihood of the rejection class (?) is 0. When the time step is 2, the likelihood of a, which is a first-ranked candidate, is less than the threshold θ₁, and thus 0.7 (an example of the value of cu described above) is assigned as the likelihood of the rejection class (?).

For the categorical distribution sequence (including a rejection class) represented in Table 3, tables representing selection of a maximum likelihood label sequence in cases of three types are Tables 4, 5, and 6. Each of Tables 4, 5, and 6 represents the process of calculating a likelihood of each label sequence candidate. Table 4 corresponds to a case in which B is used as a mapping function (a case of a conventional technology).

Table 5 corresponds to a case in which B_{M} is used as a mapping function (in the case of the basic type of this embodiment). Table 6 corresponds to a case in which B_{R} is used as a mapping function (in the case of the first modified example of this embodiment).

TABLE 4
USE THRESHOLD B⁻¹ (CONVENTIONAL TECHNIQUE)

| | 1 | B⁻¹(1) | P(1) |
|---|---|---|---|
| 1 | (Blank) | _ _ | 0.01 |
| 2 | a | aa, a_, _a | 0.29 |
| 3 | ? | ??, _?, ?_ | 0.07 |
| 4 | a? | a? | 0.63 |
| 5 | ?a | ?a | 0.00 |

In Table 4, for the convenience of description, row numbers are assigned. 1 of the first column is a label sequence of a candidate. B⁻¹(l) of the second column is a result of an application of an inverse function of the mapping function B to the label sequence l. p(l) of the third column represents a likelihood of the label sequence l. From the first row to the fifth row, label sequences are respectively, blank, “a”, “?”, “a?”, and “a”.

B⁻¹(l) corresponding to a label sequence of the blank represented in the first row is only “__”. A likelihood corresponding to this “__” is 0.1×0.1=0.01 from Table 3. In other words, the likelihood of the label sequence of the blank is 0.01.

B⁻¹(l) corresponding to a label sequence “a” of the second row is “aa”, “a_”, and “_a”. The likelihoods of these “aa”, “a_”, and “_a” can be calculated from Table 3 and are respectively 0.18, 0.09, and 0.02. 0.29 that is a sum thereof is a likelihood of the label sequence “a”.

B⁻¹(l) corresponding to a label sequence “?” of the third row is “??”, “_?”, and “_?”. The likelihoods of these “??”, “_?”, and “?_” can be calculated from Table 3 and are respectively 0.00, 0.07, and 0.00. 0.07 that is a sum thereof is a likelihood of the label sequence “?”.

B⁻¹(l) corresponding to a label sequence “a?” of the fourth row is only “a?”. A likelihood of this “a?” is 0.9×0.7=0.63 from Table 3. In other words, the likelihood of the label sequence “a?” is 0.63.

B⁻¹(l) corresponding to a label sequence “?a” of the fifth row is only “?a”. A likelihood of this “?a” is 0.0×0.2=0.00 from Table 3. In other words, the likelihood of the label sequence “?a” is 0.00.

TABLE 5
USE OF FUNCTION B_{M}⁻¹

| | 1 | B_{M}⁻¹(1) | p(1) |
|---|---|---|---|
| 1 | (Blank) | — | 0.01 |
| 2 | a | aa, a_, _a, a?, ?a | 0.92 |
| 3 | ? | ??, _?, ?_ | 0.07 |
| 4 | a? | | 0.00 |
| 5 | ?a | | 0.00 |

In Table 5 (a case in which the mapping function B_{M} is used), for the convenience of description, row numbers are assigned. As illustrated in the table, from the first row to the fifth row, candidates for the label sequence are respectively a blank, “a”, “?”, “a?”, and “?a”. Since a mapping function different from that of the case of Table 4 is used, B_{M}⁻¹(l) corresponding to a candidate I for a label sequence is different from that of the case of Table 4.

B_{M}⁻¹(l) corresponding to a label sequence of a blank of the first row is only “__”. A likelihood of this “__” is 0.01 from Table 3. In other words, the likelihood of the blank label sequence is 0.01.

B_{M}⁻¹(l) corresponding to a label sequence “a” of the second row is “aa”, “a_”, “_a”, “a?”, and “?a”. A sum of the likelihoods of these “aa”, “a_”, “_a”, “a?”, and “?a” is 0.92. In other words, the likelihood of the label sequence “a” is 0.92.

B_{M}⁻¹(l) corresponding to a label sequence “?” of the third row is “??”, “?”, and “?”. A sum of the likelihoods of these “??”, “?”, and “?” is 0.07. In other words, the likelihood of the label sequence “?” is 0.07.

For each of the label sequence “a?” of the fourth row and the label sequence “?a” of the fifth row, a corresponding B_{M}⁻¹(l) is an empty set. In other words, both the likelihood of the label sequence “a?” of the fourth row and the likelihood of the label sequence “?a” of the fifth row are 0.00.

As above, in Table 5, a label sequence having the highest likelihood among candidates for the label sequences of five types is “a”. In addition, the likelihood p(1) thereof is 0.92. In the case as illustrated in this Table 5, the label sequence selecting unit 27 selects “a” that is the label sequence having the highest likelihood and transfers the selected label sequence to the output unit 29.

In other words, while “a?” is selected as an output label sequence in a case in which a conventional technology is used (Table 4), “a” is selected as an output label sequence in a case in which the basic type of this embodiment is used (Table 5). This is in accordance with the use of B_{M} as a mapping function.

TABLE 6
USE OF FUNCTION B_{R}⁻¹

| | 1 | B_{R}⁻¹(1) | p(1) |
|---|---|---|---|
| 1 | (Blank) | _ _ | 0.01 |
| 2 | a | aa, a_, _a | 0.29 |
| 3 | ? | ??, _?, ?_ | 0.07 |
| 4 | a? | | 0.00 |
| 5 | ?a | | 0.00 |
| 6 | Exclusion | a?, ?a | 0.63 |

In Table 6 (a case in which the mapping function B_{R} is used), for the convenience of description, row numbers are assigned. As illustrated in the table, from the first row to the sixth row, candidates for the label sequence are respectively a blank, “a”, “?”, “a?”, “?a”, and exclusion. Since a mapping function different from those of the cases of Tables 4 and 5 is used, B_{R}⁻¹(l) corresponding to a candidate I for a label sequence has a feature in this example.

B_{R}⁻¹(l) corresponding to a label sequence of a blank of the first row is only “__”. A likelihood of this “__” is 0.01 from Table 3. In other words, the likelihood of the blank label sequence is 0.01.

B_{R}⁻¹(l) corresponding to a label sequence “a” of the second row is “aa”, “a_”, and “_a”. A sum of the likelihoods of these “aa”, “a_”, and “_a” is 0.29. In other words, the likelihood of the label sequence “a” is 0.29.

B_{R}⁻¹(l) corresponding to a label sequence “?” of the third row is “??”, “_?”, and “?_”. A sum of the likelihoods of these “??”, “_?”, and “?_” is 0.07. In other words, the likelihood of the label sequence “?” is 0.07.

For each of the label sequence “a?” of the fourth row and the label sequence “?a” of the fifth row, a corresponding B_{R}⁻¹(l) is an empty set. In other words, both the likelihood of the label sequence “a?” of the fourth row and the likelihood of the label sequence “?a” of the fifth row are 0.00.

The label sequence of the sixth row is an exclusion. B_{R}⁻¹(l) corresponding to this is “a?” and “?a”. From Table 3, the likelihood of “a?” is 0.63, and the likelihood of “?a” is 0.00. In other words, the likelihood of the exclusion is a sum of such likelihoods, which is 0.63.

“exclusion” represented in the sixth row of Table 6 cannot be selected as the maximum likelihood label sequence by the label sequence selecting unit 27. In other words, the label sequence selecting unit 27 selects “a” (the second row) that is a label sequence having a highest likelihood among the first row to the fifth row of Table 6. The likelihood is 0.29. The label sequence selecting unit 27 transfers the selected label sequence “a” to the output unit 29.

In other words, while “a?” is selected as an output label sequence in a case in which a conventional technology is used (Table 4), in a case in which the first modified example of this embodiment is used (Table 6), “a” is selected as an output label sequence. This is in accordance with use of B_{R} as a mapping function.

### Second Embodiment

Next, a second embodiment will be described. Hereinafter, description of items that have already been described in the previous embodiment (including the modified examples) may be omitted. Here, items that are features of this embodiment will be focused on in description.

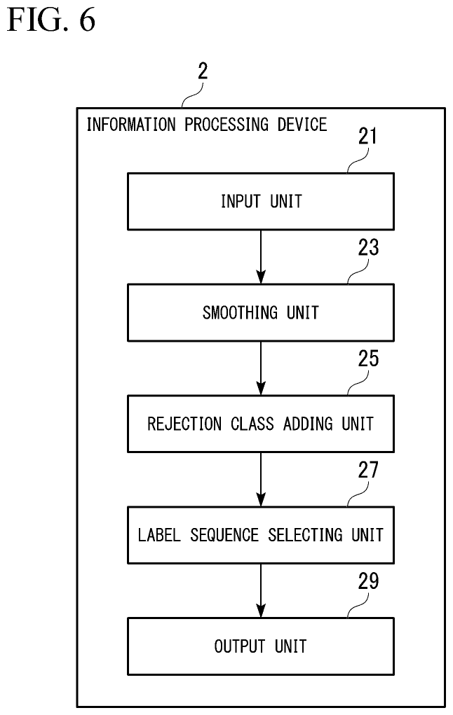

FIG. 6 is a block diagram illustrating a schematic functional configuration of an information processing device according to this embodiment. As illustrated in the drawing, the information processing device 2 is configured to include an input unit 21, a smoothing unit 23, a rejection class adding unit 25, a label sequence selecting unit 27, and an output unit 29. In other words, as a feature of this embodiment, the information processing device 2 includes the smoothing unit 23. The function of each unit other than the smoothing unit 23 is similar to that according to the first embodiment.

The smoothing unit 23 performs smoothing such that a change in elements, which are adjacent to each other, of a categorical distribution sequence acquired by the input unit 21 decreases. In other words, the smoothing unit 23 smoothens changes between categorical distributions, which are adjacent to each other, included in the categorical distribution sequence. As an example of the method, the smoothing unit 23 applies a Gaussian filter for each class. In other words, the smoothing unit 23 applies the process of a Gaussian filter in the direction of a column within the categorical distribution sequence for the value of the score for each class. In this case, the smoothing unit 23 substitutes the value of pₜ(k) with a value represented by the following Equation (19).

$$\frac{{\sum }_{r = - s}^{s} ( {w}_{r} \cdot {p}_{t + r} ( k ) )}{{\sum }_{r = - s}^{s} {w}_{r}} \qquad ( 19 )$$

In this Equation (19), s is a positive integer that is appropriately set. In addition, wᵣ is a coefficient that is appropriately set.

For example, as s=1, it may be set such that w₋₁=1, w₀=1, and w₁=1.

In addition, for example, as s=1, it may be set such that w₋₁=1, w₀=2, and w₁=1.

Furthermore, for example, as s=2, it may be set such that w₋₂=1, w₋₁=2, w₀=4, w₁=2, and w₋₂=1.

In addition, wᵣ may have a different value.

Here, in a case in which the value of (t+r) is outside the range of the categorical distribution sequence, in other words, in a case in which (t+r)<1 or (t+r)>L, corresponding items are deleted from both the numerator and the denominator of Equation (9). In other words, in this case, the value of a corresponding wᵣ may be set to 0.

The smoothing unit 23 may or may not normalize likelihood values of results smoothen by the process of Equation (19) and the like. In the case of normalization, for example, the smoothing unit 23 performs normalization such that a sum of likelihoods for each class at the position of each t (1≤t≤L) is 1. In addition, the rejection class adding unit 25 may subsequently normalize scores after addition of the rejection class regardless of whether or not the smoothing unit 23 performs a normalization process.

The function of the rejection class adding unit 25 according to this embodiment is similar to that according to the first embodiment. In this embodiment, the rejection class adding unit 25 performs a subsequent process on the basis of the categorical class sequence of results smoothed by the smoothing unit 23.

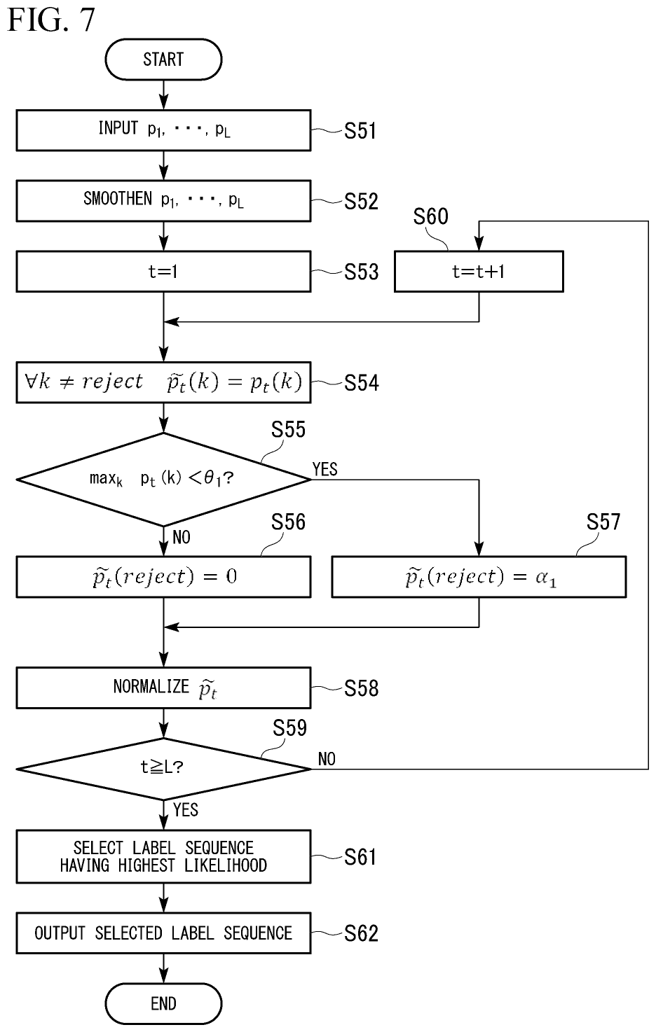

FIG. 7 is a flowchart illustrating a processing sequence of the information processing device according to this embodiment. Hereinafter, the operation of the information processing device 2 will be described along this flowchart.

In Step S51, the input unit 21 acquires categorical distribution sequences p₁, . . . , p_{L} from the outside. The process of this step corresponds to Step S1 in the flowchart (the first embodiment) illustrated in FIG. 2.

In Step S52, the smoothing unit 23 performs a process of smoothing a categorical distribution sequence, which is acquired by the input unit 21, in a series direction. As described above, the smoothing unit 23 may perform smoothing using a Gaussian filter as an example. The process of this step is a process that is a feature of this embodiment. The smoothing unit 23 transfers the categorical distribution sequence after smoothing to the rejection class adding unit 25.

Processes of Steps S53 to S62 respectively correspond to the processes of Steps S2 to S11 in the flowchart illustrated in FIG. 2. In Steps S53 to S62, the information processing device 2 has data after being smoothened in Step S52 as a processing target. Except for the point, the processes of Steps S53 to S62 are similar to the processes of Steps S2 to S11, and thus, detailed description will be omitted here.

In addition, any one of the first modified example to the fifth modified example of the first embodiment may be combined with this embodiment for the process. Also in such a case, the process of each case is performed using a result of the smoothing process performed by the smoothing unit 23.

According to this embodiment, since the smoothing unit 23 smoothens the categorical distribution sequence, rejection that is robust with respect to noises can be expected to be realized.

In each of the embodiments described above, the label sequence selecting unit 27 selects a label sequence having a highest (in other words, first-ranked) likelihood among candidates. As a modified example, the label sequence selecting unit 27 may be configured to select a label sequence other than a first-ranked label sequence (in other words, for example, a second-ranked or third-ranked label sequence or the like) among candidates. In addition, the label sequence selecting unit 27 may be configured to select a plurality of label sequences (for example, up to the n-th ranked (here, n is a positive integer) label sequences) in accordance with likelihoods among candidates. Also in such a case, the output unit 29 outputs the label sequence selected by the label sequence selecting unit 27.

In the embodiments, a plurality of modified examples have been described. Here, a plurality of modified examples may be combined as long as the combination can be performed.

According to at least one of the embodiments described above, instead of rejecting the entire series or assigning a score of rejection to the entire series, the rejection class adding unit 25 adds a rejection class having a score for each categorical distribution within the categorical distribution sequence. By including such a rejection class adding unit 25, a rejection label can be included at a specific label position within a label sequence (series) to be output.

In other words, according to at least one of the embodiments, in a recognition process performed in units of series, only a part of the series can be rejected.

As one example, in a case in which an image in which “abc” is written is recognized as characters in a character string recognition problem, the certainty factors of “a” and “c” are high, and the certainty factor of “b” is low, only “b” can be rejected in units of characters like “a?c”.

The function of the information processing device according to the embodiment described above may be realized by a computer. In such a case, by recording a program used for realizing the function on a computer-readable recording medium and causing the computer system to read and execute the program recorded on this recording medium, the function may be realized. The “computer system” described here includes an OS and hardware such as peripherals. The “computer-readable recording medium” represents a portable medium such as a flexible disc, a magneto-optical disk, a ROM, a CD-ROM, a DVD-ROM, or a USB memory or a storage device such as a hard disk built in the computer system. In other words, a “computer-readable recording medium” may be a non-transitory computer-readable recording medium. Furthermore, the “computer-readable recording medium” may include a medium dynamically storing the program for a short time such as a communication line of a case in which the program is transmitted through a network such as the Internet or a communication circuit line such as a telephone line and a medium storing the program for a predetermined time such as an internal volatile memory of the computer system that becomes a server or a client in such a case. The program described above may be a program used for realizing a part of the function described above or a program that can realize the function described above in combination with a program that is already recorded in the computer system.

While several preferred embodiments of the invention have been described and illustrated above, it should be understood that these embodiments are presented as examples and are not intended to limit the scope of the invention. These embodiments may be performed in various other forms, and additions, omissions, substitutions, and other modifications can be made without departing from the spirit or scope of the present invention. These embodiments and modifications thereof are included in the scope or spirit of the present invention and, similarly, are included in the scope of the invention defined in the claims and the scope of equivalency thereof. Accordingly, the invention is not to be considered as being limited by the foregoing description, and is only limited by the scope of the appended claims.

### EXPLANATION OF REFERENCES

1, 2 Information processing device
21 Input unit
23 Smoothing unit
25 Rejection class adding unit
27 Label sequence selecting unit
29 Output unit

What is claimed is:

1. An information processing device comprising:
a rejection class adding unit configured to add a rejection class by acquiring a categorical distribution sequence formed by aligning a plurality of categorical distributions having scores for each class and acquiring a score of a rejection class on the basis of the categorical distribution for each of the categorical distributions included in the categorical distribution sequence;
a label sequence selecting unit configured to calculate likelihoods of label sequence candidates corresponding to the categorical distribution sequence on the basis of the categorical distribution sequence after addition of the rejection class and select a label sequence among a plurality of the label sequence candidates in accordance with the likelihoods of the label sequence candidates; and
an output unit configured to output the selected label sequence.

2. The information processing device according to claim 1,
wherein the classes include a blank class corresponding to a blank, a rejection class corresponding to a rejection, and other normal classes,
wherein the blank class corresponds to a blank label,
wherein the rejection class corresponds to a rejection label,
wherein each of the normal classes corresponds to one normal label,
wherein the label sequence selecting unit acquires a first label sequence likelihood of each first label sequence on the basis of the likelihoods of the classes included in the categorical distribution sequence,
wherein the label sequence selecting unit sets a result acquired by applying a predetermined mapping function to the first label sequences as second label sequences and acquires a second label sequence likelihood of each of the second label sequences on the basis of the first label sequence likelihoods of the first label sequences associated with the second label sequences in accordance with the mapping function, and
wherein the label sequence selecting unit sets the second label sequences as the label sequence candidates and selects the label sequence from among the second label sequences on the basis of the second label sequence likelihoods.

3. The information processing device according to claim 2,
wherein the mapping function is a function that performs an operation of deleting the blank label from the first label sequence, in a case in which consecutive identical labels are present within the first label sequence, substituting the consecutive identical labels with only one of the labels, and, in a case in which there is a position at which the normal label and the rejection label are consecutive within the first label sequence, deleting the rejection label and causing the normal label to remain regardless of whether one of the normal label and the rejection label precedes the other and sets a result of the operation as the second label sequence.

4. The information processing device according to claim 2,
wherein the mapping function is a function that performs an operation of deleting the blank label from the first label sequence and, in a case in which consecutive identical labels are present within the first label sequence, substituting the consecutive identical labels with only one of the labels and sets a result of the operation as the second label sequence and is a function that sets an exclusion target label sequence as the second label sequence regardless of whether one of the normal label and the rejection label precedes the other in a case in which there is a position at which the normal label and the rejection label are consecutive within the first label sequence.

5. The information processing device according to claim 1,
wherein the classes include a blank class corresponding to a blank, a rejection class corresponding to a rejection, and other normal classes,
wherein the blank class corresponds to a blank label,
wherein the rejection class corresponds to a rejection label,
wherein each of the normal classes corresponds to one normal label,
wherein the label sequence selecting unit acquires a first label sequence likelihood of each first label sequence on the basis of the likelihoods of the classes included in the categorical distribution sequence,
wherein the label sequence selecting unit selects a predetermined number of the first label sequences from among a plurality of the first label sequences in accordance with the first label sequence likelihoods and selects second label sequences that are results of applying a predetermined mapping function to the selected first label sequences as the label sequence, and
wherein the mapping function is a function that performs an operation of deleting the blank label from the first label sequence and, in a case in which consecutive identical labels are present within the first label sequence, substituting the consecutive identical labels with only one of the labels and sets a result of the operation as the second label sequence.

6. The information processing device according to claim 1, wherein the rejection class adding unit sets a value that monotonously decreases with respect to a score of a class that is a first-ranked candidate within the categorical distribution as a score of the rejection class.

7. The information processing device according to claim 6, wherein the rejection class adding unit sets the score of the rejection class to a lowest value among scores of all the classes in a case in which the score of the class that is the first-ranked candidate within the categorical distribution is equal to or more than a predetermined threshold (θ₁) and sets the score of the rejection class to a predetermined value other than the lowest value in a case in which the score of the class that is the first-ranked candidate within the categorical distribution is less than the predetermined threshold (θ₁)

8. The information processing device according to claim 1, wherein the rejection class adding unit sets the score of the rejection class to a lowest value among scores of all the classes in a case in which a difference between a first-ranked score of a class that is a first-ranked candidate within the categorical distribution and a second-ranked score of a class that is a second-ranked candidate within the categorical distribution is equal to or more than a predetermined threshold (θ₂) and sets the score of the rejection class to a predetermined value other than the lowest value in a case in which the difference between the first-ranked score of the class that is the first-ranked candidate within the categorical distribution and the second-ranked score of the class that is the second-ranked candidate within the categorical distribution is less than the predetermined threshold (θ₂).

9. The information processing device according to claim 6, wherein the rejection class adding unit sets the score of the rejection class to a lowest value among scores of all the classes in a case in which a score of a class that is the first-ranked candidate within the categorical distribution is equal to or more than a predetermined threshold (θ₁) or in a case in which the class that is the first-ranked candidate is not a blank class corresponding to a blank.

10. The information processing device according to claim 1, further comprising a smoothing unit configured to smoothen changes between the categorical distributions, which are adjacent to each other, included in the categorical distribution sequence.

11. The information processing device according to claim 10, wherein the smoothing unit applies a process of a Gaussian filter in a direction of a column within the categorical distribution sequence for a value of a score of each class.

12. An information processing method comprising:
adding a rejection class by acquiring a categorical distribution sequence formed by aligning a plurality of categorical distributions having scores for each class and acquiring a score of a rejection class on the basis of the categorical distribution for each of the categorical distributions included in the categorical distribution sequence;
calculating likelihoods of label sequence candidates corresponding to the categorical distribution sequence on the basis of the categorical distribution sequence after addition of the rejection class and selecting a label sequence among a plurality of the label sequence candidates in accordance with the likelihoods of the label sequence candidates; and
outputting the selected label sequence.

13. A program causing a computer to execute a process of:
adding a rejection class by acquiring a categorical distribution sequence formed by aligning a plurality of categorical distributions having scores for each class and acquiring a score of a rejection class on the basis of the categorical distribution for each of the categorical distributions included in the categorical distribution sequence;
calculating likelihoods of label sequence candidates corresponding to the categorical distribution sequence on the basis of the categorical distribution sequence after addition of the rejection class and selecting a label sequence among a plurality of the label sequence candidates in accordance with the likelihoods of the label sequence candidates; and
outputting the selected label sequence.
